(19) United States
(12) Patent Application Publication
(10) Pub. No.: US 2026/0319069 A1
(43) Pub. Date: Oct. 15, 2026

(54) VEHICULAR RADAR SENSING SYSTEM FOR IN-CABIN MONITORING WITH OCCUPANT HEALTH MONITORING

(71) Applicant: Magna Electronics Inc., Auburn Hills, MI (US)

(72) Inventor: Rohan Shreemurthy, Karnataka (IN)

(21) Appl. No.: 19/641,750

(22) Filed: Apr. 8, 2026

Related U.S. Application Data
(60) Provisional application No. 63/785,782, filed on Apr. 9, 2025.
(60) Provisional application No. 63/809,424, filed on May 21, 2025.

(51) Int. Cl. G01S 7/41; B60W 40/08; G01S 13/88

(52) U.S. Cl. CPC G01S 7/41; B60W 40/08; G01S 13/88; B60W 2040/0872; B60W 2420/408

(57) ABSTRACT

A vehicular cabin monitoring system includes a radar sensor disposed within an interior cabin of a vehicle. The system detects an occupant present within the interior cabin of the vehicle and extracts a complex peak value corresponding to the detected occupant across a plurality of frames of the sensor data. The system extracts and unwraps a phase component of the complex peak value across the plurality of frames to generate an unwrapped phase signal. The system applies an empirical wavelet transformation (EWT) to the unwrapped phase signal to decompose the unwrapped phase signal into a plurality of intrinsic mode functions (IMFs). The system isolates a first portion of the IMFs attributable to a body movement of the occupant and a second portion attributable to a vital sign of the occupant. The system determines a health condition of the occupant based on the second portion of the IMFs.

### CROSS REFERENCE TO RELATED APPLICATION

The present application claims priority of U.S. provisional application Ser. No. 63/809,424, filed May 21, 2025 and U.S. provisional application Ser. No. 63/785,782, filed Apr. 9, 2025, which are hereby incorporated herein by reference in their entireties.

### FIELD OF THE INVENTION

The present invention relates generally to a vehicular cabin monitoring system for a vehicle and, more particularly, to a vehicular cabin monitoring system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular cabin monitoring system includes a radar sensor disposed within an interior cabin of a vehicle equipped with the vehicular cabin monitoring system. The radar sensor senses within the interior cabin of the vehicle. The system includes an electronic control unit (ECU), and sensor data captured by the radar sensor is transferred to the ECU. The ECU includes electronic circuitry and associated software, and the electronic circuitry of the ECU includes a processor operable to process sensor data transferred to the ECU. The vehicular cabin monitoring system, via processing at the ECU of sensor data captured by the radar sensor, monitors a region within the interior cabin of the vehicle. The vehicular cabin monitoring system, via processing at the ECU of the sensor data captured by the radar sensor, detects an occupant present in the region within the interior cabin of the vehicle based on the sensor data. The vehicular cabin monitoring system extracts a complex peak value corresponding to the detected occupant across a plurality of frames of the sensor data. The vehicular cabin monitoring system extracts and unwraps a phase component of the complex peak value across the plurality of frames to generate an unwrapped phase signal. The vehicular cabin monitoring system applies an empirical wavelet transformation (EWT) to the unwrapped phase signal to decompose the unwrapped phase signal into a plurality of intrinsic mode functions (IMFs). The vehicular cabin monitoring system isolates a first portion of the IMFs attributable to a body movement of the occupant and a second portion of the IMFs attributable to a vital sign of the occupant. The vehicular cabin monitoring system determines a health condition of the occupant based on a spectral analysis of the second portion of the IMFs.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle having a vehicular cabin monitoring system;

FIG. 2 is a schematic diagram of a radar sensor detecting vital signs of an occupant of the vehicle;

FIG. 3 is a plot of the Bessel function of the first kind for varying order;

FIG. 4 is a plot of the spectrum of the vital sign signal;

FIG. 5 is a plot of a chirp signal;

FIG. 6 is a plot representing derivation of the constant-frequency intermediate frequency signal from the transmitted and received chirp signals;

FIG. 7 is a plot of a cycle of chirps spaced in time;

FIG. 8 is a flow diagram of an example method of estimating breathing rate of an occupant of the vehicle based on radar sensor data;

FIG. 9 shows empirical wavelet transform (EWT) of a signal decomposed into its intrinsic mode functions (IMFs);

FIG. 10 shows setups for collecting data representative of human breathing;

FIG. 11 is a table of data including breathing rate estimation for different frequencies played at a speaker in FIG. 10;

FIGS. 12 and 13 are plots of speaker signals and estimated breathing rates;

FIG. 14 shows a setup for collecting data from a human subject;

FIG. 15 is a table of data including breathing rate estimation during different movements of the human subject;

FIGS. 16 and 17 are plots of radar sensor data and estimated breathing rates for the human subject;

FIG. 18 is a plot of a speaker signal of 0.5 Hz decomposed into different frequency bands; and

FIG. 19 is a Hilbert transform of intrinsic mode functions.

### DESCRIPTION OF THE PREFERRED EMBODIMENTS

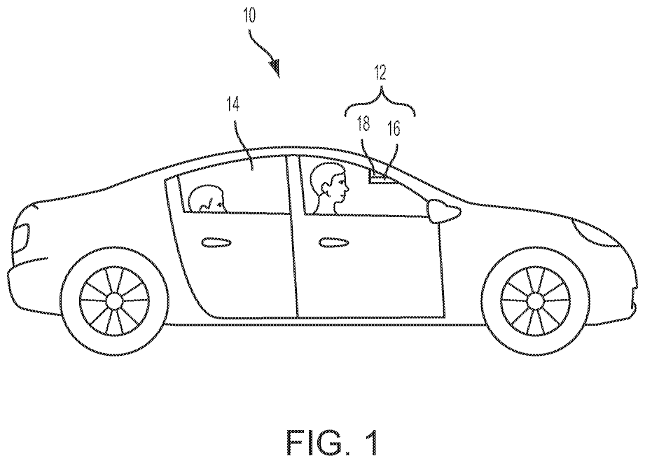

Referring now to the drawings and the illustrative embodiments depicted therein, a vehicular cabin monitoring system 12 for a vehicle 10 is configured to detect presence of occupants within the interior cabin 14 of the vehicle 10 (FIG. 1). For example, the system 12 may include one or more radar sensors 16 disposed at the interior cabin 14 of the vehicle 10 and that sense respective regions of the interior cabin 14 of the vehicle 10. The system 12 further includes a control or electronic control unit (ECU) 18 that includes electronic circuitry and associated software, such as a data processor or image processor for processing sensor data captured by the one or more sensors 16, whereby the ECU 18 may process sensor data captured by the one or more radar sensors 16 to detect presence of occupants, determine conditions of the occupants, and the like, as discussed further below. Although shown as disposed at an overhead console module of the vehicle 10, it should be understood that the one or more sensors 16 and/or the ECU 18 may be disposed at any suitable portion of the interior cabin 14 of the vehicle 10 for sensing regions of the interior cabin 14, such as at an interior rearview mirror assembly, a light module (e.g., a reading light or dome light), a grab handle module, and/or at or behind the vehicle headliner. The data transfer or signal communication from the one or more sensors 16 to the ECU 18 may comprise any suitable data or communication link, such as a vehicle network bus or the like of the equipped vehicle.

The cabin monitoring system 12 may capture and process sensor data to monitor respective regions of the interior cabin of the vehicle and determine health conditions or vital signs for the driver and/or one or more occupants of the vehicle seated in the respective regions. For example, the cabin monitoring system 12 may monitor the driver region, a front passenger region, a rear second row passenger region, a rear third row passenger region, and the like.

Vital sign estimation using radar may check the heartbeat and breathing rate of occupants within the vehicle without physically touching the occupants. That is, the device sends out invisible waves and these waves bounce off the occupant's body and come back to the device, which then figures out how fast the occupant's heart is beating and how the occupant is breathing.

Estimating vital signs with random body movements can be challenging. When a person moves, the movement creates extra signals that can confuse the sensor trying to measure the heartbeat and breathing rate. The sensor may include a radar sensor. The radar sensor has to distinguish between the vital signs and the movements, which can be challenging. These movements can cause errors or make the readings less accurate.

The cabin monitoring system may solve this issue by identifying instances where random body movements have occurred. As these movements introduce interference into the radar signal, they are to be separated from the required signal. The interference-prone segments are detected first and then the noisy signals caused by body motion are removed from the actual signal. Once the vital sign components are isolated, the radar can focus on these clean signals to estimate accurate heartbeat and breathing rate values, even if the person is moving. This makes the monitoring process more reliable and effective, ensuring that the vital signs are measured correctly despite any disturbances.

As discussed further below, the vehicular cabin monitoring system processes sensor data captured by one or more in-cabin radar sensors to determine a portion of the sensor data representative of an occupant of the vehicle. Then, the system may determine a first part of the portion of the sensor data that is attributable to body movement of the occupant and a second part of the portion of the sensor data that is attributable to a vital sign of the occupant (e.g., heartbeat and/or breathing rate of the occupant). The system determines a health condition of the occupant based on the second part of the portion of the sensor data. The system may perform empirical wavelet transformations (EWTs) to determine intrinsic mode functions (IMFs) for the captured radar sensor data. This may isolate the parts of the sensor data attributable to vital signs of the occupant and the health condition may be determined based on these parts of the sensor data.

In-cabin sensing has become one of the key safety features in the automobile industry. Frequency-Modulated Continuous Wave (FMCW) radar technology is increasingly being utilized for in-cabin sensing in the automotive industry. FMCW radar systems offer precise and reliable detection of vital signs such as respiratory rate and heart rate by measuring the minute movements of the chest and abdomen caused by breathing and heartbeats. This technology operates by emitting continuous waves with varying frequency and analyzing the reflected signals to determine the distance and movement of objects within the cabin. The respiratory breathing rate can be estimated by sensing the movement of the chest and abdomen, which is based on the thoracoabdominal vibration association caused by human breathing.

Random body movements present one of the most challenging issues in vital sign estimation. The large and irregular displacement of the human body can corrupt the vital sign signal and significantly degrade the accuracy of the estimation. During operation of the cabin monitoring system, the characteristics of the vital sign signal under body movement are analyzed and decomposed into a set of monocomponent signals called intrinsic mode functions (IMFs) using EWT. EWT generates a large number of IMFs, making it important to select the fundamental IMFs and eliminate the redundant ones.

Simulations of the theory using a model of targets with vital signs are conducted, followed by experiments to validate the theory. These experiments are carried out on speakers and human subjects.

Millimeter-wave (mmWave) radar technology may assist noninvasive vital sign monitoring. This technology operates in the frequency range of 30 GHz to 300 GHZ, offering high resolution and sensitivity, which are essential for detecting minute physiological movements such as heartbeats and respiratory patterns. Unlike traditional methods that require physical contact or visual line-of-sight, mmWave radar can accurately measure vital signs through clothing and other obstructions, making it ideal for applications in healthcare, automotive, and smart home environments.

The principle behind mmWave radar for vital sign monitoring involves transmitting electromagnetic waves and analyzing the reflected signals from the human body. The periodic movements of the chest and abdomen caused by breathing and heartbeats modulate the reflected radar signals, allowing the extraction of vital sign information. The high frequency of mmWave radar enables precise detection of these small movements, providing reliable and continuous monitoring.

In the automotive industry, in-cabin sensing using mmWave radar can enhance passenger safety by monitoring the health status of occupants, detecting the presence of children, and alerting drivers to potential health issues.

Typical non-contact vital sign detection systems have primarily focused on stationary subjects. One of the most significant challenges in non-contact vital sign detection is the presence of random body movements.

Remote or non-contact vital sign detection relies on sensing minute physiological movements, ranging from several millimeters to several centimeters. These movements are typically associated with the chest wall's displacement due to breathing and heartbeats. However, random body movements, which can have displacements comparable to or even larger than those caused by vital signs, introduce substantial noise into the system. This noise can corrupt the signal of interest and significantly degrade the accuracy of vital sign detection.

Random body movements pose a considerable challenge because they can mask the subtle physiological signals that the detection system aims to capture. For instance, movements such as shifting position, adjusting posture, or involuntary twitches can generate displacements that interfere with the radar's ability to accurately measure vital signs. The challenge is further compounded in dynamic environments, such as in-cabin sensing in vehicles, where occupants may frequently move.

Overcoming the challenge of random body movements remains critical for improving their accuracy and applicability in real-world scenarios.

Empirical Wavelet Transform (EWT) is a sophisticated signal processing technique that enhances the estimation of vital signs amidst random body movements. Traditional methods often struggle with non-stationary signals, where the frequency content changes over time, making it difficult to accurately extract vital sign information. EWT addresses this challenge by adaptively decomposing the signal into a set of empirical wavelets, each tailored to capture specific frequency components. The process begins with partitioning the Fourier spectrum of the signal into different frequency bands based on the significant frequency components. For each band, an empirical wavelet is constructed, designed to be localized in both time and frequency domains. This allows EWT to isolate vital sign components, such as respiratory rate, from the noise introduced by body movements.

Signal processing techniques may be used for time division multiplexing (TDM) multiple-input multiple-output (MIMO) frequency modulated continuous wave (FMCW) millimeter-wave radar sensors.

The decomposition is achieved by convolving the signal with the empirical wavelets, resulting in a set of wavelet components that represent different frequency bands. The original signal can be reconstructed by summing these components, ensuring no information is lost. By effectively separating physiological signals from motion artifacts, EWT improves the accuracy and reliability of vital sign monitoring in dynamic environments.

Non-contact vital sign detection using radar technology has applications in healthcare, automotive, and smart home environments. The Empirical Wavelet Transform (EWT) is a novel signal processing technique designed to handle non-stationary signals by adaptively decomposing them into empirical wavelets. This method partitions the Fourier spectrum of the signal into different frequency bands and constructs wavelets that are localized in both time and frequency domains. EWT may isolate specific signal components from noise, making it particularly useful for vital sign monitoring in dynamic environments.

Frequency-Modulated Continuous Wave (FMCW) millimeter wave sensors may be used for monitoring vital signs of multiple people simultaneously. FMCW sensors may be capable of accurately detecting heart rate and respiration rate even in the presence of body movements.

Intrinsic Mode Functions (IMFs) may be used in the Empirical Mode Decomposition (EMD) method, specifically applied to heart sound signals. Redundant IMFs may pose a challenge and criteria for selecting the most relevant IMFs may use Jensen Renyi divergence and Minkowski distance. This contributes to improving the accuracy of heart sound signal analysis by refining the EMD process.

A method for measuring respiration rate under one-dimensional body motion may use a single continuous-wave Doppler radar system. The system may be able to accurately detect respiration rate despite body movements, making it suitable for non-contact vital sign monitoring applications.

A systematic approach for heartbeat monitoring may use FMCW millimeterwave radar. The system demonstrates the radar's effectiveness in detecting heartbeats with high precision, even in the presence of motion artifacts. This technology may provide continuous and non-invasive heart rate monitoring.

The system may use a time-window-variation technique for fast acquisition of heart rate in non-contact vital sign radar measurements. The method significantly reduces the time required to detect heart rate, enhancing the efficiency of radar-based vital sign monitoring systems.

The system may provide an accurate non-contact vital sign detection method using Doppler radar and the RELAX algorithm. The system may precisely detect heart rate and respiration rate, even in challenging conditions with significant noise and motion artifacts.

The system may provide continuous body movement-robust respiration rate detection using FMCW millimeter-wave radar and non-negative matrix factorization algorithm. The system effectively isolates respiration signals from body movement noise, ensuring reliable respiration rate monitoring.

The transmitted signal may be

x_{T}(t)=s(t)e^{i2πf}^{_{c}}^{t}
where s (t), 0≤t≤T is the baseband signal.

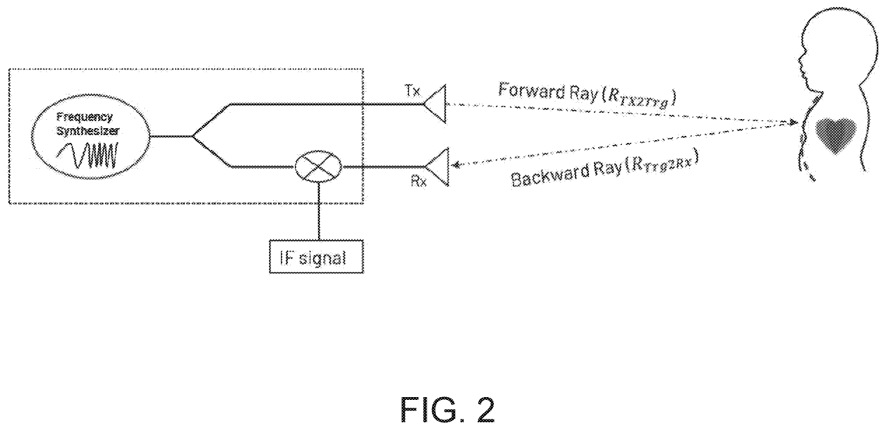

After hitting the human body, the phase of the transmitted signal is modulated by the physiological movement r (t), which includes the chest wall displacement due to respiration shown in FIG. 2.

$${x}_{R} ( t ) = {x}_{T} ( t - \frac{2 r ( t )}{c} )$$

where r (t)=r₀+vt, r₀ is the initial range at t=0.

$${x}_{R} ( t ) = s ( t - \frac{2 ( {r}_{0} + vt )}{c} ) {e}^{i 2 π {f}_{c ( t - \frac{2 ( {r}_{0} + vt )}{c} )}} \approx s ( t - \frac{2 {r}_{0}}{c} ) {e}^{\frac{- i 2 π {f}_{c} {r}_{0}}{c}} {e}^{\frac{- i 2 π {f}_{c} vt}{c}} {e}^{i 2 π {f}_{c} t}$$

since 2v/c is negligible, Doppler shift is

$$\frac{2 {f}_{c} v}{c} = \frac{2 v}{λ} Hz$$

Because respiration causes range to vary harmonically, then

$$r ( t ) = r + {D}_{0} sin ( 2 π {f}_{v} t )$$

$${x}_{R} ( t ) = s ( t - \frac{2 ( {r}_{0} + {D}_{v} sin ( 2 π {f}_{v} t ) )}{c} ) {e}^{i 2 π {f}_{c} ( t - \frac{2 ( {r}_{0} + {D}_{v} sin ( 2 π {f}_{v} t ) )}{c} )} \approx s ( t - \frac{2 {r}_{0}}{c} ) {e}^{i 2 π {f}_{c} ( t - \frac{2 ( {r}_{0} + {D}_{v} sin ( 2 π {f}_{v} t ) )}{c} )}$$

$$since$$

$$\frac{2 {D}_{v} sin ( 2 π {f}_{v} t )}{c}$$

$$is negligible$$

$$\approx s ( t - \frac{2 {r}_{0}}{c} ) {e}^{i 2 π {f}_{c} t} {e}^{- i \frac{4 π}{β} {D}_{v} sin ( 2 π {f}_{v} t )} {e}^{- i \frac{4 π {f}_{c} {r}_{0}}{c}}$$

$${x}_{R} ( t ) = Re [ \text{?} {e}^{i 2 π {f}_{c} t} ]$$

complex envelope of

x_{R}(t)
is

$$\text{?}$$

$$\text{?} \approx Ks ( t - \frac{2 {r}_{0}}{c} ) {e}^{- i \frac{4 π}{β} {D}_{v} sin ( 2 π {f}_{v} t )} \approx Ks ( t - \frac{2 {r}_{0}}{c} ) {e}^{i β sin ( 2 π {f}_{v} t )}$$

$$where$$

$$β = \frac{- 4 π {D}_{v}}{λ} , {A}_{k} = {e}^{\frac{- 4 π {f}_{c} {r}_{0}}{c}}$$

The complex envelope [symbol] is a periodic function of time with a fundamental frequency fᵥ equal to and period Tᵥ=1/fᵥ. This can be expanded in the form of a complex Fourier series as follows.

$$\text{?} = {\sum }_{n = - ∞}^{∞} {c}_{n} {e}^{i 2 π {nf}_{v} t}$$

where the complex Fourier coefficient

$${c}_{n} = {f}_{v} {\int }_{- \frac{1}{2 {f}_{v}}}^{\frac{1}{2 {f}_{v}}} \text{?} {e}^{- j 2 π {nf}_{v} t} dt$$

$$\frac{A k}{2 π} {\int }_{- π}^{π} {e}^{- j ( β sin x - nx )} dt$$

$$c = {KJ}_{n} ( β )$$

The integral on the right hand side of the equation above except for the term Ak is referred to as the nth order Bessel function of the first kind and argument B.

$${J}_{n} ( β ) = \frac{1}{2 π} {\int }_{- π}^{π} {e}^{- j ( β sin x - nx )} dt$$

$$\text{?} = {\sum }_{n = - ∞}^{∞} {c}_{n} {e}^{i 2 π {nf}_{v} t} = A [ {J}_{0} ( β ) + {J}_{- 1} ( β ) {e}^{- j 2 π {f}_{v} t} + {J}_{1} ( β ) {e}^{j 2 π {f}_{v} t} + … ]$$

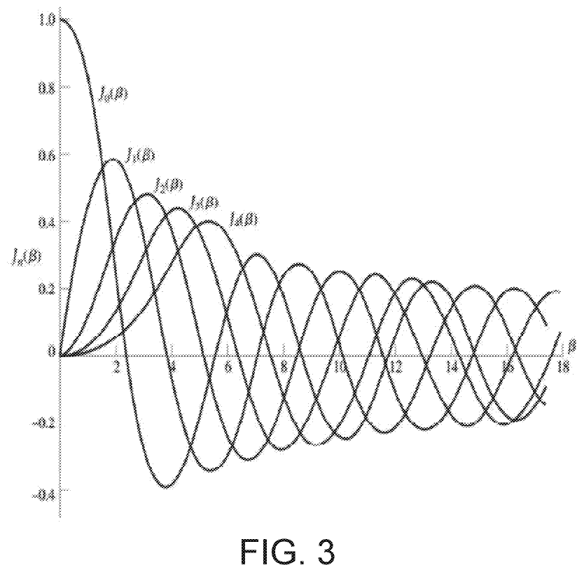

FIG. 3 is a plot of the Bessel function of the first kind, Jn (B), for varying order n.

$$\text{?} = {\sum }_{n = - ∞}^{∞} {c}_{n} δ ( f - {nf}_{v} ) = A [ {J}_{0} ( β ) δ ( f ) - {J}_{1} ( β ) δ ( f + {f}_{v} ) + {J}_{1} ( β ) δ ( f + {f}_{v} ) + … ]$$

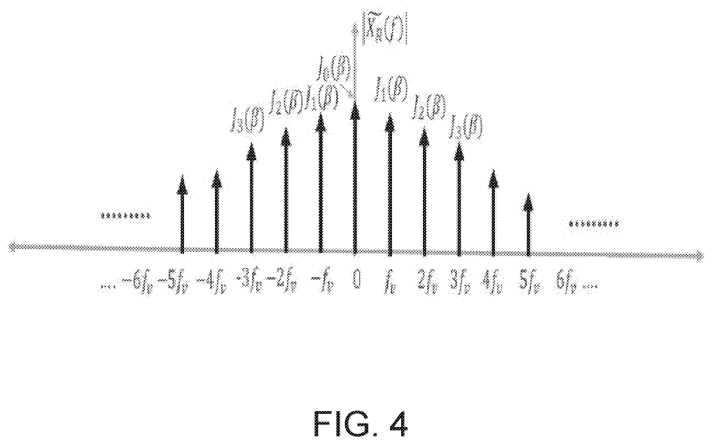

FIG. 4 is a plot of the spectrum of the vital sign signal.

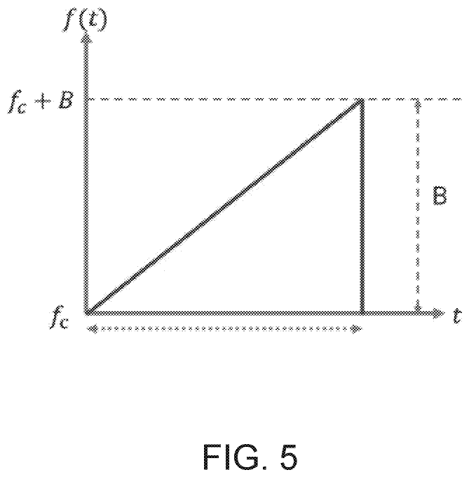

The radar transmits a signal that linearly increases in frequency over the duration of one pulse repetition interval (PRI). This means that during each PRI, the frequency of the transmitted signal starts at a lower value and continuously rises to a higher value in a linear fashion as shown in FIG. 5. This type of signal may be referred to as a chirp signal and it may be used in radar systems to improve range resolution and target detection capabilities.

A radar system emits a signal X_{T}(t) from its transmitter antenna (Tx). When this signal encounters an object, a portion of the signal energy, known as radar returns or echoes, is reflected back to the radar receiver antenna (Rx), where it is received as the signal x_{R}(t). The radar system processes the received signal x_{R}(t) to extract information such as range, velocity, angle, and other target characteristics for detection, localization, tracking, and monitoring vital signs.

The Frequency Modulated Continuous Wave (FMCW) signal is defined by its start frequency f, bandwidth B, and pulse repetition interval T_{c}, which is the time duration between consecutive pulses. Angular frequency is represented by ω_{c}=2πf_{c}, where f_{c} is the initial start frequency of the waveform. The FMCW signal over the time duration T_{c} is referred to as a chirp. The frequency of the chirp signal increases linearly over time at a rate S=β/T_{c} shown in FIG. 5.

A sinusoidal FMCW signal can be represented as,

x_{T}(t)=cos(2πf_{c}t+πSt²)
with the instantaneous frequency given by,

$$f ( t ) = \frac{1}{2 π} \frac{d}{dt} ( 2 π {f}_{c} t + π {St}^{2} ) = {f}_{c} + St$$

These parameters are used for defining the behavior and performance of the FMCW radar system. The initial start frequency sets the baseline frequency from which the signal begins to sweep. The bandwidth determines the extent of the frequency sweep, impacting the resolution and accuracy of the radar measurements. The pulse repetition interval influences the timing and rate at which pulses are transmitted, affecting the radar's ability to detect and track targets.

FIG. 5 represents the frequency over time of the FMCW chirp signal with the start frequency f_{c}, bandwidth B, slope S, and time duration T_{c}.

The received signal is both delayed in time and shifted in frequency due to the Doppler effect. To process this received signal, it is mixed with a replica of the transmitted signal. The radar receiver mixes the received signal x_{R}(t) with the transmitted signal X_{T}(t) and applies a low-pass filter to the resulting signal to produce the intermediate frequency (IF) signal x_{IF}(t). As the frequency of the FMCW signal x_{T}(t) increases linearly over time, the instantaneous frequencies of x_{T}(t) and X_{R}(t), denoted as f_{T}(t) and f_{R}(t), respectively, differ at the time of mixing. The low-pass filtering process removes the signal component with frequency f_{T}(t)+f_{R}(t) while allowing the signal component with frequency f_{T}(t)−f_{R}(t) to pass through. LPF denotes the low-pass filter operation. This process can be represented as

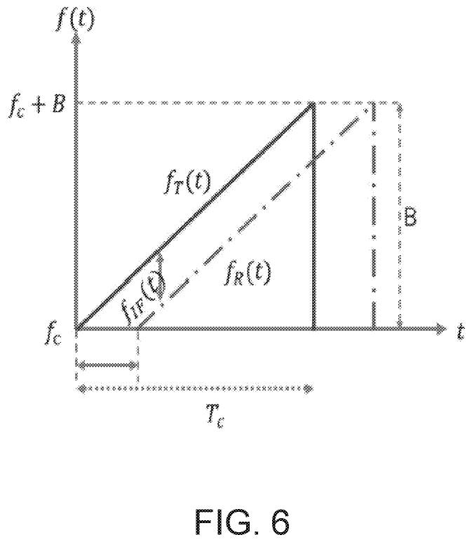

x_{IF}(t)=LPF{x_{T}(t)x_{R}(t)}=A cos(2πf_{IF}t+φ_{IF})
where f_{IF}=f_{T}(t)−f_{R}(t) as shown in FIG. 6.

FIG. 6 is the frequency over time of delayed/doppler shifted received signals and represents deriving the constant-frequency intermediate frequency (IF) signal from the transmitted and received chirp signals.

For an object at a range r₀ (i.e., distance) from the radar, the transmitted signal is reflected back by the object and arrives at the receiver antenna after a delay τ=2 t₀/c, where c is the speed of light. Therefore,

$${f}_{IF} = {f}_{T} ( t ) - {f}_{R} ( t ) = S τ = \frac{2 S {r}_{0}}{c}$$

where S is the slope of the linearly increasing frequency of the chirp signal. The phase φ_{IF} is given by

$${ϕ}_{IF} = 2 π {f}_{c} τ + π S {τ}^{2} \approx 2 π {f}_{c} τ = \frac{{4}^{π {r}_{0}}}{λ}$$

where λ is the wavelength of the transmitted signal.

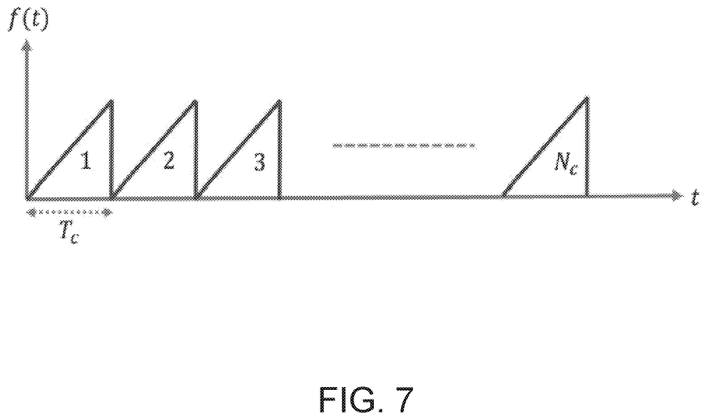

To measure the doppler of an object, radar can transmit multiple chirps [Nc] separated by a time interval T_{c} as shown in FIG. 7. If the object's velocity is v, it will travel a distance of Δr=vT_{c} during the time interval T_{c}. Based on the intermediate frequency (IF) signal model described in equations above, the differences in frequency and phase between the IF signals derived from the two chirps are

$$Δ f = \frac{2 S Δ r}{c} = \frac{2 {SvT}_{c}}{c}$$

$$Δϕ = \frac{4 π Δ r}{λ} = \frac{4 π {vT}_{c}}{λ}$$

When the time interval T_{c} is small, the frequency difference Δf is negligible compared to the frequency of the IF signal. However, the phase difference Δφ can be detected even when the movement Δr is on the order of millimeters, which is comparable to the wavelength λ of the mmWave chirp signals.

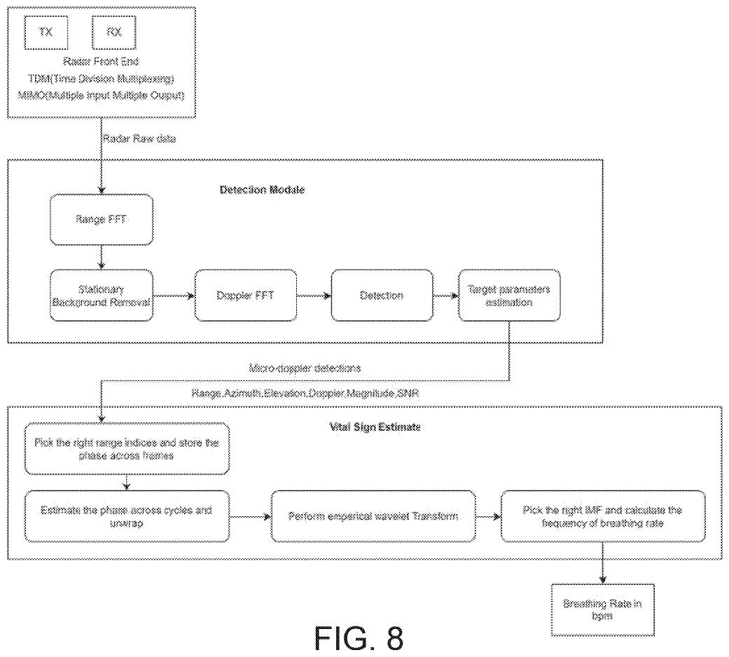

The block diagram in FIG. 8 shows steps involved in the detection and estimation of vital signs. Time Division Multiplexing (TDM) and Multiple-Input Multiple-Output (MIMO) are used to enhance their performance. TDM works by dividing the available time into distinct slots, allowing multiple signals to share the same communication channel without interference. Each signal is transmitted sequentially in its allocated time slot, ensuring efficient utilization of the bandwidth. On the other hand, MIMO leverages multiple antennas for both transmission and reception, significantly improving the radar's resolution, detection capability, and range. By combining TDM with MIMO, radar systems can achieve superior spatial resolution and target tracking. The effective number of virtual antennas in a TDM MIMO radar system can be represented mathematically as Nᵥₓₛ=Nₜₓₛ×Nᵣₓₛ, where Nₜₓₛ is the number of transmitting antennas and Nᵣₓₛ is the number of receiving antennas. This increase in virtual antennas directly translates to enhanced performance, making TDM MIMO radars highly effective in various applications.

The initial step involves processing the sampled raw radar data, which contains the Intermediate Frequency (IF) signal. The data is first directed to the detection module for further analysis. To enhance the quality of the signal and minimize noise, the data undergoes preprocessing. This involves averaging the signal across multiple chirps, which effectively reduces random noise and improves the overall signal-to-noise ratio. The range information, which is used for determining the distance to targets, is embedded within the fast time axis of the radar data. This axis represents the time intervals corresponding to the transmission and reception of radar pulses.

The dimensions of the radar raw data are represented as Nᵥₓₛ×N_{rngSamples}, where Nᵥₓₛ denotes the number of virtual antennas, and N_{rngSamples} signifies the number of samples captured within each chirp. This structure allows for comprehensive data collection across multiple antennas and time intervals. To mitigate the effects of sidelobes, which can introduce unwanted artifacts and reduce the accuracy of target detection, the radar raw data is multiplied by a window function. This window process smooths the data, thereby enhancing the quality of the subsequent analysis.

The next step involves performing a Fast Fourier Transform (FFT) on the windowed data along the fast time axis. This transformation converts the time-domain data into the frequency domain, resulting in the generation of the range spectrum. The range spectrum provides a clear representation of the distances to various targets, facilitating accurate range measurement and target identification.

To accurately estimate and detect living objects, which exhibit micro-Doppler effects due to their movement, it is essential to eliminate reflections from stationary backgrounds. These static reflections can obscure the detection of dynamic targets. The removal of stationary background reflections is achieved by subtracting the samples of the current radar frame from those of the previous frame. This differential approach effectively highlights changes between frames, isolating moving objects from the static environment. By focusing on the detection of objects with micro-Doppler effects, the radar system can better identify and track living entities. Micro-Doppler effects are small frequency shifts caused by the movement of parts of the target, such as limbs, which may be used for distinguishing living objects from stationary ones.

To facilitate comprehensive analysis and ensure the availability of sufficient data for subsequent processing stages, the range spectrum data is stored in a buffer. This buffer accumulates data over 64 chirps, providing a robust dataset for further analysis. The dimensions of the range buffer are defined as Nᵥₓₛ×N_{rngSamples}×N_{frames}, where Nᵥₓₛ represents the number of transmitting antennas, N_{rngSamples} indicates the number of samples captured within each chirp, and N_{frames} denotes the total number of frames stored in the buffer. This structure ensures that the buffer can accommodate data from multiple antennas and frames, enabling detailed and accurate processing.

Estimating the noise floor is an important step in radar signal processing, as it helps in distinguishing actual targets from background noise. In the context of interior cabin sensing applications, this estimation is performed by analyzing the initial few near-range bins. These bins are selected because the likelihood of a target being present in these close proximity ranges is minimal. The noise floor is determined by calculating the median value of the samples within these near-range bins. The median is chosen as it provides a robust measure of the central tendency, effective filtering out any outliers and ensuring a reliable estimation of the background noise level. By accurately estimating the noise floor, the radar system can enhance its sensitivity and improve the detection of genuine targets, particularly in environments where the signal-to-noise ratio is critical for performance.

To further analyze the motion characteristics of detected targets, and an additional FFT is performed on the range buffer data, this time along the Doppler axis. This step is used for identifying frequency shifts that are indicative of target movement. The result of this Doppler FFT is the creation of a Range-Doppler (RD) map. This map provides a comprehensive visual representation that correlates the range (distance) of targets with their Doppler shifts (velocity). The RD map is instrumental in distinguishing between stationary and moving objects, as well as in identifying the micro-Doppler effects caused by smaller, more nuanced movements of targets. By generating the RD map, the radar system gains valuable insights into the dynamic behavior of potential targets, enabling more accurate detection, tracking, and classification of moving objects within the observed environment.

The detection module plays a critical role in identifying potential targets from the RD map. Once these targets are detected, the relevant information is forwarded to the estimation module for further analysis. The estimation module is responsible for determining various parameters of the detected targets, which are essential for accurate characterization and tracking. These parameters include range and magnitude. Range represents the distance between the radar system and the target. Accurate range estimation is important for determining the position of the target within the observed environment. The magnitude parameter measures the strength or intensity of the target signal. It is indicative of the target's reflectivity and can provide insights into the target's size and material properties.

Azimuth indicates the horizontal angle of the target relative to the radar system. It helps in pinpointing the target's location in the horizontal plane. Elevation refers to the vertical angle of the target, providing information about the target's position in the vertical plane. This parameter is particularly important in three-dimensional target localization. The phase difference between the signals received at different antennas is used to estimate the angle of arrival (AoA). This phase difference is related to the target's azimuth and elevation angles. For a target at azimuth angle θ and elevation angle φ, the phase shift Δφ between two antennas separated by distance d is given by

$$Δ ϕ = \frac{2 π d}{λ} sin ( θ ) cos ( ϕ )$$

where λ is the wavelength of the radar signal. The azimuth angle is calculated based on the phase differences along the horizontal axis of the virtual array. The elevation angle is calculated based on the phase differences along the vertical axis of the virtual array (if a 3D array configuration is used). For a 2D array (e.g., ULA), only the azimuth angle is typically estimated. For a 3D array, (e.g., URA), both azimuth and elevation angles can be estimated.

The process of converting estimated parameters into valid detections involves filtering and validating the data to ensure accuracy and reliability. This step is important for subsequent stages of radar data processing. The estimated parameters, such as range, azimuth, elevation, and magnitude, are analyzed to identify and confirm the presence of genuine targets. This involves applying thresholding techniques and consistency checks to differentiate between true targets and noise or false alarms. Once validated, these detections are formatted and stored in a structured manner, making them readily accessible for use by downstream modules. These modules may include vital sign estimation, which monitors physiological parameters; localization, which determines the precise position of targets; and classification, which identifies and categorizes different types of targets. By ensuring that only valid detections are passed on, the radar system enhances its overall performance and reliability, providing accurate and actionable information for various applications.

Initial detections are identified and their positions are localized within the radar's field of view. This step involves analyzing the radar data to pinpoint potential targets and determine their approximate locations. To ensure the reliability and accuracy of the detections, a selection process is employed. Detections are evaluated based on their SNR and their persistence over time. Only those detections that meet the required thresholds for SNR and have a consistent presence over multiple frames are considered valid. Once the valid detections are identified, the corresponding range bins are extracted from the range spectrum. The range bin represents the specific distance interval within which the target is located. The final step involves selecting the most appropriate detection based on the range information. This ensures that the detection with the highest confidence and accuracy is chosen for further processing and analysis.

From the range spectrum, the peak complex value is extracted from the range bin corresponding to a valid detection. The peak value is a complex number that includes both magnitude and phase information. The magnitude indicates the strength of the reflected radar signal, while the phase contains vital information about the target's movement, such as the subtle motions associated with breathing. To ensure robust analysis, these complex values are accumulated over a minimum of 128 frames. Accumulating data over multiple frames enhances the reliability of the measurements and allows for the detection of consistent patterns over time. The phase component of the complex value is particularly important for applications like vital sign monitoring. At each frame, the phase is extracted and then unwrapped. Phase unwrapping is a process that corrects for discontinuities in the phase data, ensuring a continuous and accurate representation of the target's motion. This is important for accurately tracking periodic movements, such as breathing cycles. By storing and processing these values across multiple frames, the radar system can perform detailed temporal analysis. This enables the detection of long-term trends and periodic behaviors, which are essential for applications such as health monitoring, where consistent and accurate tracking of physiological parameters is required.

The unwrapped phase of the radar signal is modulated by the frequency corresponding to the breathing rate of the living object. This phase modulation is used for accurately determining the breathing rate. However, the phase data can be susceptible to corruption due to sudden body movements of other external factors. These disruptions can introduce noise and distortions into the phase signal, which is intended to capture the subtle movements associated with breathing. Such phase corruption poses a significant challenge, as it can lead to inaccurate estimations of the breathing rate. Erroneous phase data can result in false readings, which may compromise the reliability of applications that depend on precise vital sign monitoring.

To effectively address the issue of phase corruption, the empirical wavelet transform (EWT) is utilized. The EWT is a powerful signal processing technique designed to decompose complex signals into their constituent components. By applying EWT, the radar signal can be decomposed in such a way that the component containing the breathing rate information is isolated from other interfering signals. This decomposition allows for a more precise extraction of the desired signal, filtering out noise and other artifacts that may corrupt the phase data. The separation achieved through EWT significantly enhances the accuracy of breathing rate estimation. By isolating the true breathing signal, EWT ensures that the phase data used for estimating the breathing rate is free from distortions caused by sudden body movements or other external factors. Employing EWT in the signal processing pipeline not only improves the reliability of vital sign monitoring and also enhances the overall performance of the radar system in detecting and tracking subtle physiological movements. By implementing these steps, the process ensures a more reliable and accurate estimation of the breathing rate, even in the presence of potential interferences.

That is, the IF signal obtained from the radar receiver is first sent to the processor, where a Range FFT (Fast Fourier Transform) is performed across the fast time samples within the chirps. Some of the stationary detections are calculated, these stationary detections are then utilized by other modules to monitor environmental changes, such as seat positions, sensor misalignment, and blockages or occlusions in footwells and seats.

To focus on moving targets, the stationary background is removed. This process ensures that only the signals corresponding to moving objects are retained. Following the removal of the stationary background, a Doppler FFT is performed across cycles to analyze the velocity of the detected objects.

Using detection techniques on the Range-Doppler (RD) map, potential peaks are identified and sent to the estimation module. This module estimates various parameters, including the object's position coordinates (x, y, z), azimuth, elevation, Signal-to-Noise Ratio (SNR), and amplitude.

The basic detections are then filtered to eliminate clutter and redundant detections, ensuring a clean and accurate detection list. This refined list of detections is subsequently passed to further modules, such as the Vital Sign Estimator, Localizer, and Classifier, for more advanced processing and analysis.

To estimate vital signs, it is necessary to extract the phase information from the target's range bins across cycles through phase demodulation and compensation. However, there are two primary challenges. First, short-term body movements of the target can interfere with frequencies that are close to those of respiratory signals, making it difficult for traditional filters to accurately extract vital signs. The Empirical Wavelet Transform (EWT) signal processing technique offers a solution to this problem by aiming to estimate the Intrinsic Mode Functions (IMFs).

The second challenge is that slight body movements can cause changes in the target's range bin across cycles, complicating the extraction process.

The Empirical Wavelet Transform (EWT) is a signal processing technique designed to address the challenges of extracting vital signs from radar signals. The EWT aims to estimate the Intrinsic Mode Functions (IMFs) of a signal. The process involves the following steps.

First, segmentation of the Fourier Spectrum. The Fourier spectrum of the signal x(t) is segmented into N contiguous frequency bands. Let ωᵢ be the boundary frequencies, where i=1, 2, . . . , N.

Second, construction of empirical wavelet functions. For each frequency band, an empirical scaling function φᵢ(t) and an empirical wavelet function with ψᵢ(t) are constructed. The wavelet function is designed to be localized in both time and frequency domains.

Third, filtering and extraction. The signal x(t) is filtered using the empirical wavelet functions to extract the IMFs. The filtering process can be represented as

IMFᵢ(t)=F⁻¹[F(x(t))ψᵢ(ω)]
where F denotes the Fourier transform, F⁻¹ denotes the inverse Fourier transform, and ψᵢ(ω) is the Fourier transform of the empirical wavelet function ωᵢ(t).

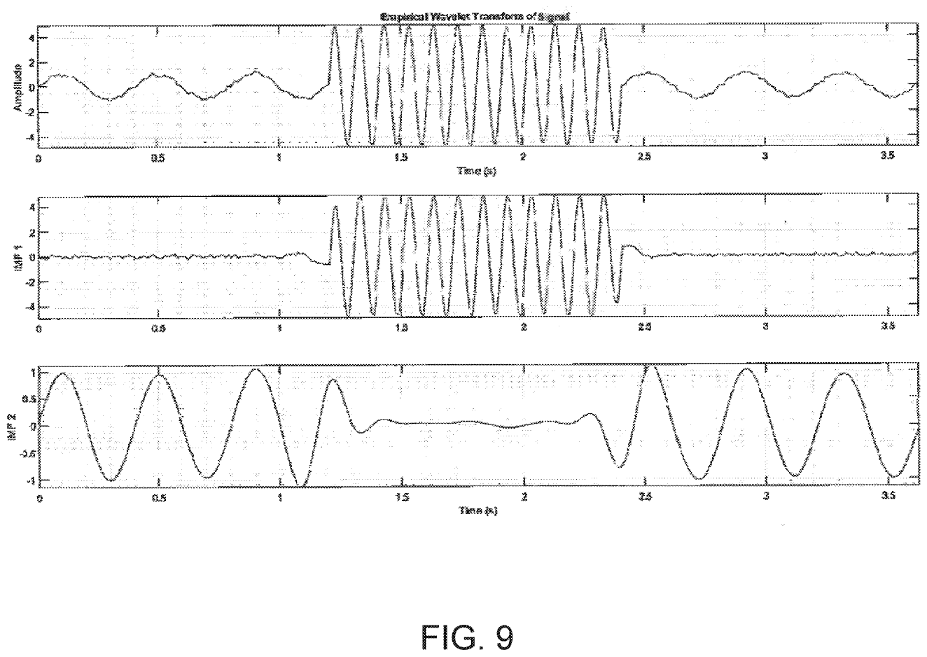

The EWT technique effectively decomposes the signal into its constituent IMFs, allowing for accurate extraction of vital signs even in the presence of short-term body movements. FIG. 9 shows the EWT of a signal containing frequencies of 0.25 Hz and 1 Hz sampled at a rate of Fₛ=10 Hz decomposed into its IMFs.

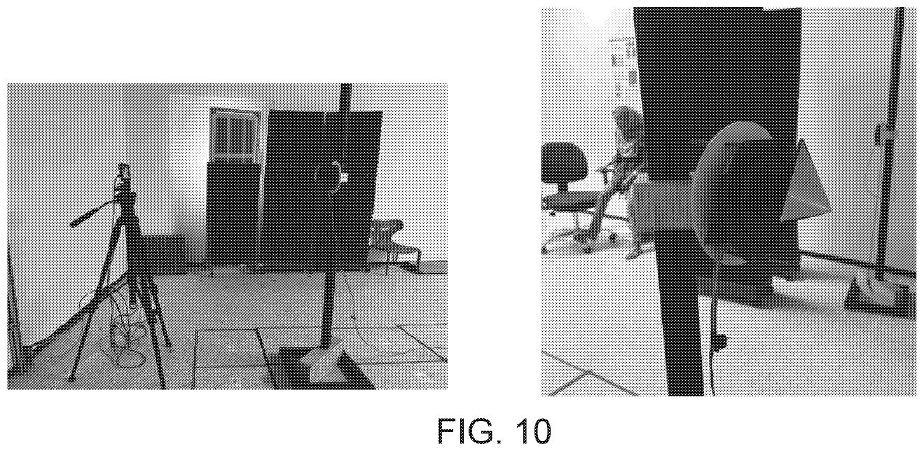

The data obtained using a speaker attached to a corner reflector, designed to simulate human breathing patterns, is displayed in the left-side of FIG. 10.

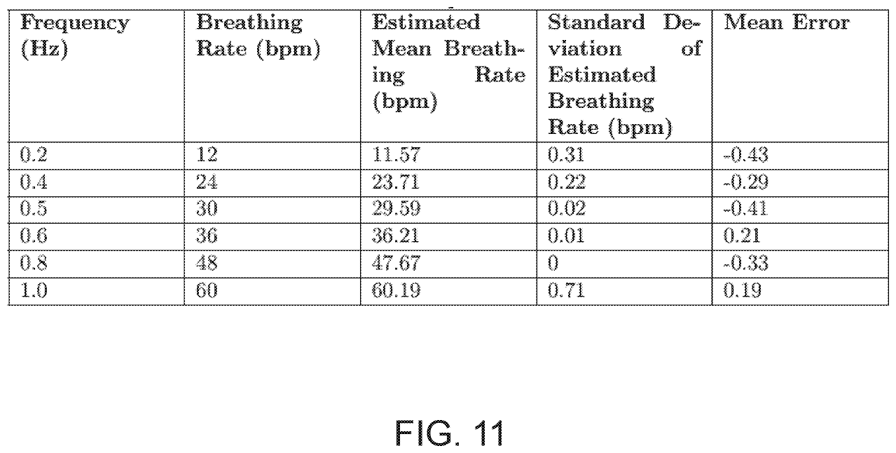

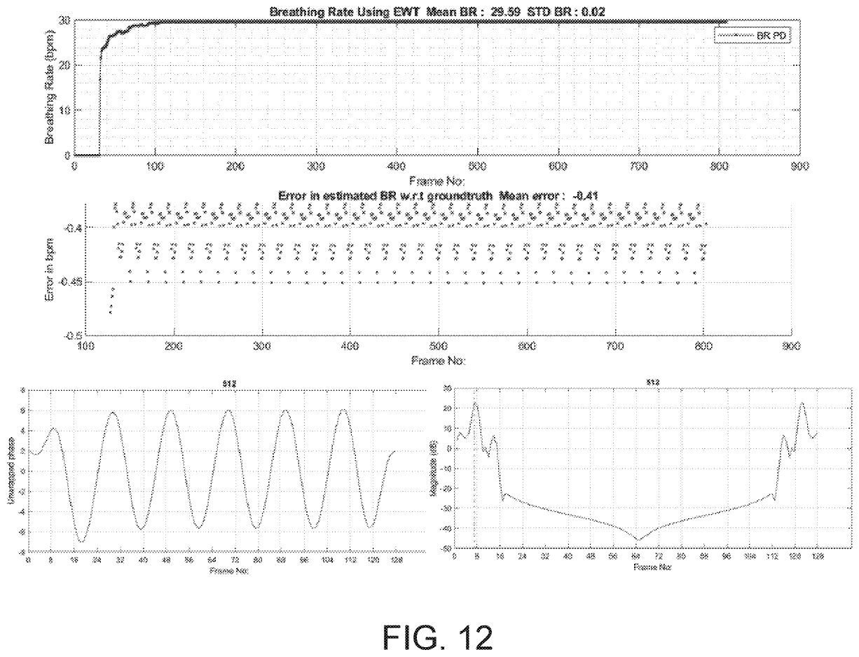

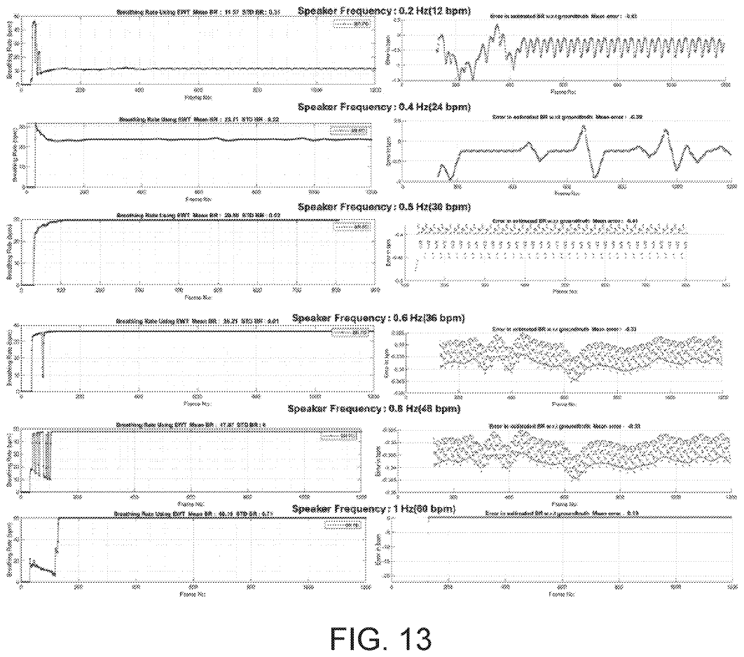

As shown in the table of FIG. 11, the speaker data includes frequency, breathing rate, estimated mean breathing rate, standard deviation of the estimated breathing rate, and mean error. FIG. 12 illustrates the breathing rate estimation for a speaker with a frequency of 0.5 Hz (30 beats per minute) across frames. The top subplot illustrates the estimated breathing rate, the middle subplot depicts the error between the estimated and actual breathing rates, and the bottom subplot shows the vital phase along with its magnitude spectrum for a specific frame. FIG. 13 provides a comprehensive view of the estimated breathing rate and errors for different frequencies, demonstrating the algorithm's performance across various settings.

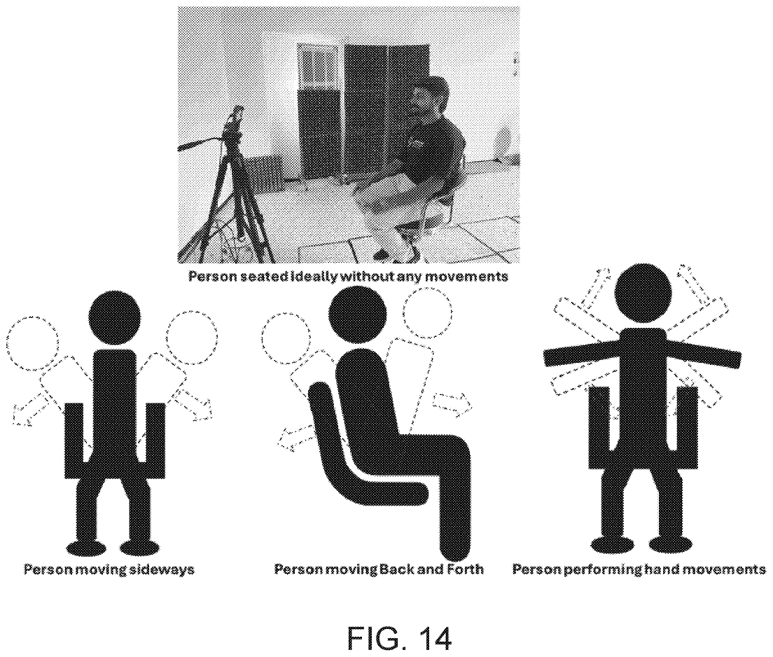

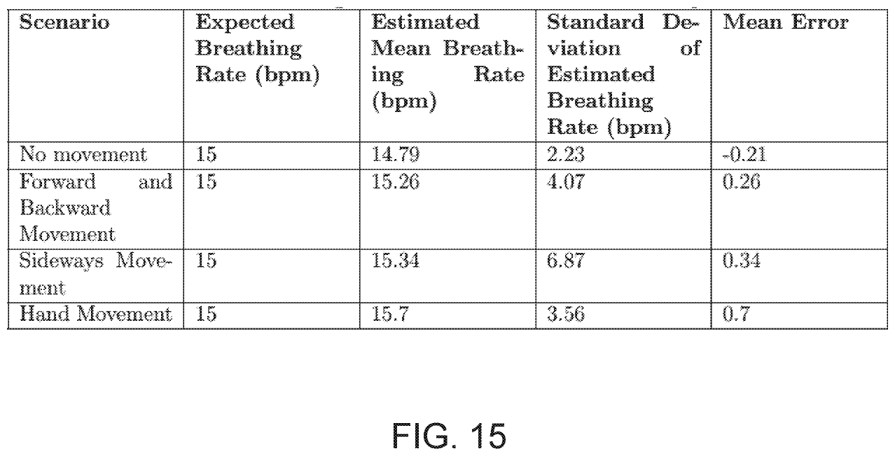

FIG. 14 shows the setup used to evaluate vital sign estimation with a human subject with the human subject making various movements, such as moving sideways, moving forward and backward, and moving hands. The table in FIG. 15 represents the results of the vital sign estimation for different scenarios involves human subjects. It includes the expected breathing rate, estimated mean breathing rate, standard deviation of the estimated breathing rate, and mean error.

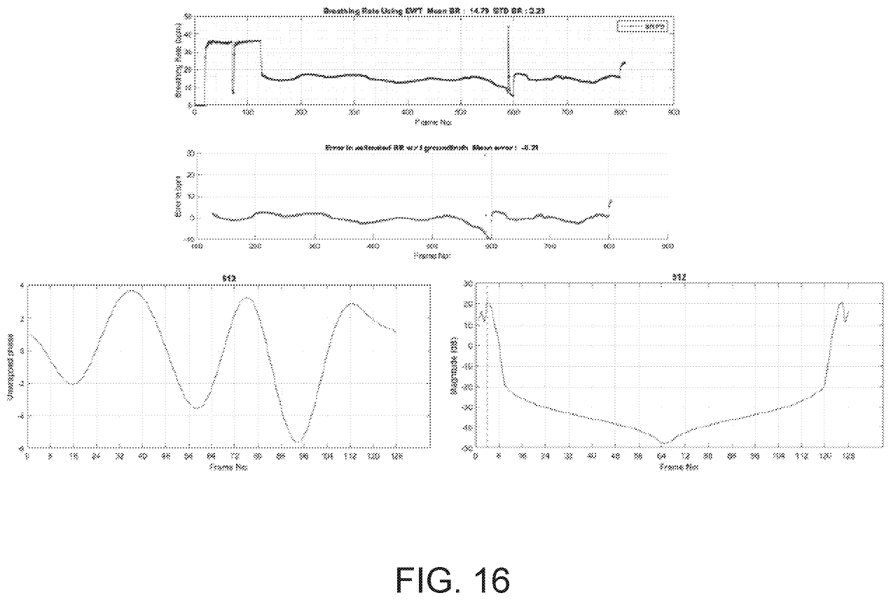

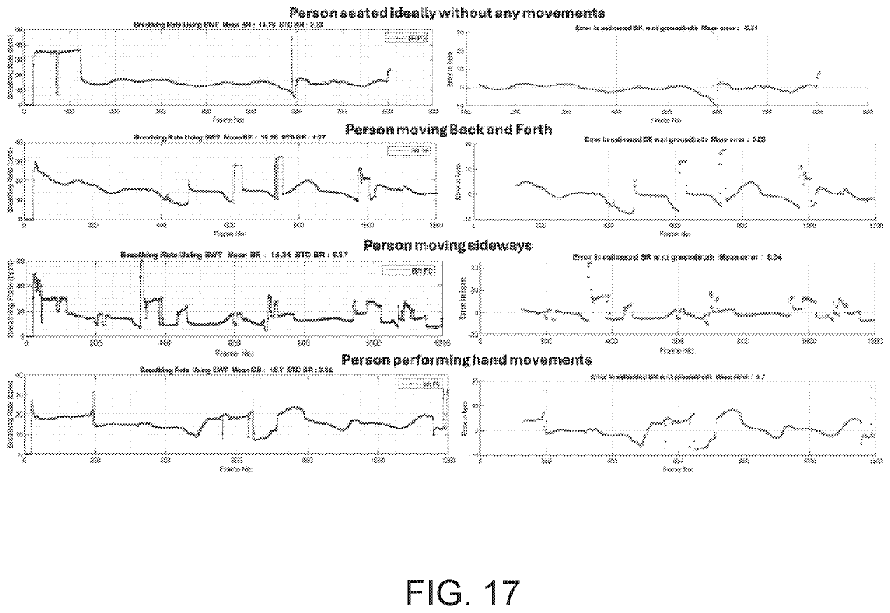

As illustrated in FIG. 16, the breathing rate estimation for a stationary occupant, who is seated without any body movements and has a breathing rate of 15 beats per minute, is depicted across multiple frames. The top subplot illustrates the estimated breathing rate, the middle subplot displays the error between the estimated and actual breathing rates, and the bottom subplot presents the vital phase along with its magnitude spectrum for a specific frame. Furthermore, FIG. 17 offers a detailed analysis of the estimated breathing rate of the corresponding errors under different conditions of interference caused by body movements. This figure demonstrates the algorithm's performance across various scenarios, highlighting its robustness and accuracy in estimating breathing rates amidst varying levels of physical activities.

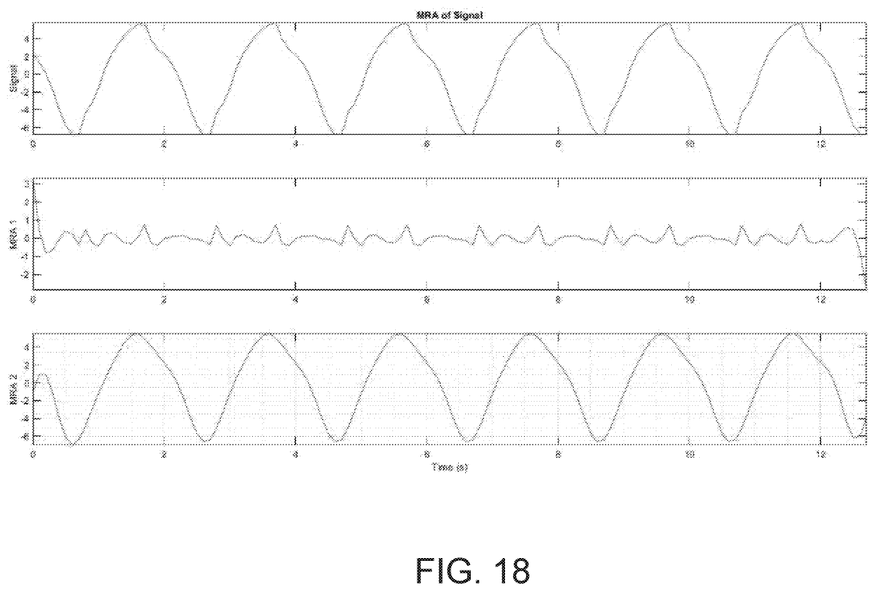

Empirical Wavelet Transform (EWT) is employed to decompose the phase extracted from the range map into multiple frequency bands as shown in FIG. 18. This decomposition allows the system to isolate and analyze specific frequency components. By focusing on the frequency band that corresponds to the breathing rate, the system can accurately estimate the actual breathing rate from the signal.

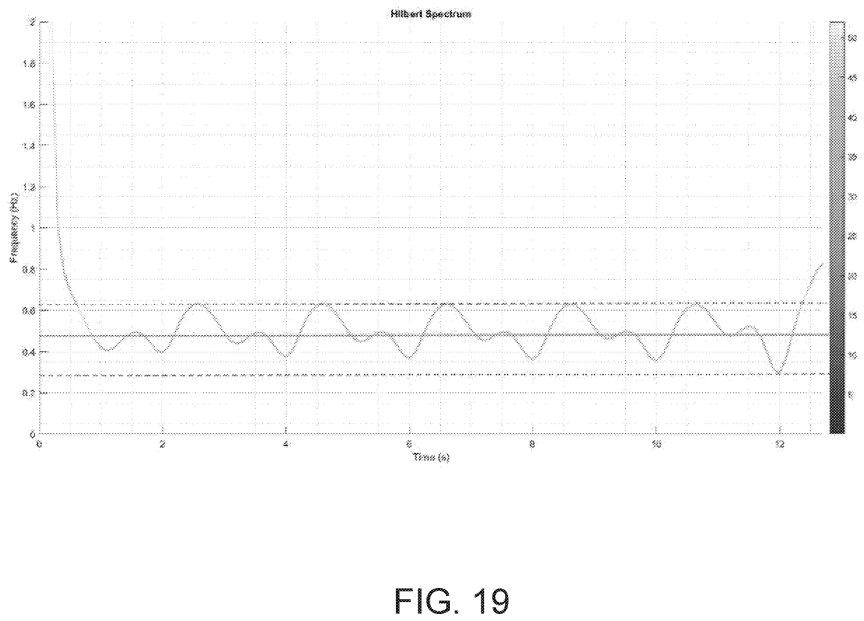

Power P spectral density (PSD) of the Intrinsic Mode Functions (IMFs) derived from the original signal using Empirical Wavelet Transform (EWT) and Hilbert-Huang Transform. This illustration in FIG. 19 provides insights into the frequency characteristics and energy distribution of the signal components.

To estimate the breathing rate, we focus on analyzing the lower frequency bands of the signal. These bands typically contain the vital information related to respiratory activity. By performing a power spectral density (PSD) analysis on these lower frequency components, we can transform the signal from the time domain to the frequency domain.

The Empirical Wavelet Transform (EWT) adaptively decomposes a signal into its intrinsic mode functions (IMFs), making it highly effective for estimating vital signs. This is particularly important because vital sign signals are often corrupted by random body movements, which are inherently nonstationary. EWT's ability to adapt to these non-stationary characteristics allows for more accurate extraction of vital sign information, even in the presence of such interference. However, the effectiveness of this technique can be compromised if the level of interference is excessively high. The technique may be refined by considering how multiple factors, such as different types and intensities of interference, affect the performance of EWT in vital sign estimation.

Random body movements may impact signal accuracy with remote vital sign detection. EWT is employed to decompose vital signals into IMFs. EWT is effective in isolating the fundamental IMFs while eliminating redundant ones. This careful selection process significantly mitigates the noise introduced by random body movements, thereby enhancing the accuracy of vital sign estimation. Using EWT provides a marked improvement in signal clarity and detection precision. By effectively filtering out noise and focusing on the relevant IMFs, EWT provides a robust framework for accurate remote vital sign detection. EWT may be used in other practical applications, such as remote health monitoring and non-invasive medical diagnostics. Identifying improved signal processing techniques may accurately localize targets and obtain precise phase information, as the phase is a critical factor in estimating the breathing rate. The application of EWT in vital sign estimation may provide a valuable approach in overcoming challenges posed by random body movements, resulting in more reliable and accurate remote vital sign detection systems.

The system thus may utilize sensors, such as radar sensors or imaging radar sensors, to detect presence of and/or range to objects. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving monitoring system of the vehicle or occupant monitoring system of the vehicle or cabin monitoring system of the vehicle or driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:
a radar sensor disposed within an interior cabin of a vehicle equipped with the vehicular cabin monitoring system, wherein the radar sensor senses within the interior cabin of the vehicle;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the radar sensor, monitors a region within the interior cabin of the vehicle;
wherein the vehicular cabin monitoring system, via processing at the ECU of the sensor data captured by the radar sensor, detects an occupant present in the region within the interior cabin of the vehicle based on the sensor data;
wherein the vehicular cabin monitoring system extracts a complex peak value corresponding to the detected occupant across a plurality of frames of the sensor data;
wherein the vehicular cabin monitoring system extracts and unwraps a phase component of the complex peak value across the plurality of frames to generate an unwrapped phase signal;
wherein the vehicular cabin monitoring system applies an empirical wavelet transformation (EWT) to the unwrapped phase signal to decompose the unwrapped phase signal into a plurality of intrinsic mode functions (IMFs);
wherein the vehicular cabin monitoring system isolates a first portion of the IMFs attributable to a body movement of the occupant and a second portion of the IMFs attributable to a vital sign of the occupant; and
wherein the vehicular cabin monitoring system determines a health condition of the occupant based on a spectral analysis of the second portion of the IMFs.

2. The vehicular cabin monitoring system of claim 1, wherein the health condition comprises at least one selected from the group consisting of (i) a heartrate of the occupant and (ii) a breathing rate of the occupant.

3. The vehicular cabin monitoring system of claim 1, wherein the region comprises a driver region within the interior cabin of the vehicle, and wherein the occupant comprises a driver of the vehicle.

4. The vehicular cabin monitoring system of claim 1, wherein the region comprises a passenger region within the interior cabin of the vehicle.

5. The vehicular cabin monitoring system of claim 1, wherein the body movement of the occupant comprises a random body movement.

6. The vehicular cabin monitoring system of claim 5, wherein the random body movement comprises at least one selected from the group consisting of (i) movement of the occupant side-to-side relative to a seating position of the occupant, (ii) movement of the occupant front-to-back relative to the seating position of the occupant, and (iii) hand movement of the occupant.

7. The vehicular cabin monitoring system of claim 1, wherein the radar sensor comprises a Frequency-Modulated Continuous Wave (FMCW) radar sensor.

8. The vehicular cabin monitoring system of claim 1, wherein the vehicular cabin monitoring system performs a Fast Fourier Transform (FFT) on the sensor data to generate a range spectrum, and wherein the vehicular cabin monitoring system extracts the complex peak value from a range bin of the range spectrum corresponding to the detected occupant.

9. The vehicular cabin monitoring system of claim 1, wherein, prior to detecting the occupant, the vehicular cabin monitoring system removes stationary background reflections from the sensor data by subtracting samples of a current radar frame from samples of a previous radar frame.

10. The vehicular cabin monitoring system of claim 1, wherein the spectral analysis of the second portion of the IMFs comprises performing a power spectral density (PSD) analysis on a lower frequency band of the second portion of the IMFs to determine the health condition.

11. A method for monitoring a vehicular cabin, the method comprising:
receiving, at an electronic control unit (ECU) comprising a processor, sensor data captured by a radar sensor disposed within an interior cabin of a vehicle;
monitoring, via processing at the ECU of the sensor data, a region within the interior cabin of the vehicle;
detecting, via the processing at the ECU, an occupant present in the region within the interior cabin of the vehicle based on the sensor data;
extracting, via the processing at the ECU, a complex peak value corresponding to the detected occupant across a plurality of frames of the sensor data;
extracting and unwrapping, via the processing at the ECU, a phase component of the complex peak value across the plurality of frames to generate an unwrapped phase signal;
applying, via the processing at the ECU, an empirical wavelet transformation (EWT) to the unwrapped phase signal to decompose the unwrapped phase signal into a plurality of intrinsic mode functions (IMFs);
isolating, via the processing at the ECU, a first portion of the IMFs attributable to a body movement of the occupant and a second portion of the IMFs attributable to a vital sign of the occupant; and
determining, via the processing at the ECU, a health condition of the occupant based on a spectral analysis of the second portion of the IMFs.

12. The method of claim 11, wherein the health condition comprises at least one selected from the group consisting of (i) a heartrate of the occupant and (ii) a breathing rate of the occupant.

13. The method of claim 11, wherein the region comprises a driver region within the interior cabin of the vehicle, and wherein the occupant comprises a driver of the vehicle.

14. The method of claim 11, wherein the region comprises a passenger region within the interior cabin of the vehicle.

15. The method of claim 11, wherein the body movement of the occupant comprises a random body movement.

16. The method of claim 15, wherein the random body movement comprises at least one selected from the group consisting of (i) movement of the occupant side-to-side relative to a seating position of the occupant, (ii) movement of the occupant front-to-back relative to the seating position of the occupant, and (iii) hand movement of the occupant.

17. The method of claim 11, wherein the radar sensor comprises a Frequency-Modulated Continuous Wave (FMCW) radar sensor.

18. The method of claim 11, further comprising performing, via the processing at the ECU, a Fast Fourier Transform (FFT) on the sensor data to generate a range spectrum, wherein extracting the complex peak value comprises extracting the complex peak value from a range bin of the range spectrum corresponding to the detected occupant.

19. The method of claim 11, further comprising, prior to detecting the occupant, removing, via the processing at the ECU, stationary background reflections from the sensor data by subtracting samples of a current radar frame from samples of a previous radar frame.

20. The method of claim 11, wherein the spectral analysis of the second portion of the IMFs comprises performing a power spectral density (PSD) analysis on a lower frequency band of the second portion of the IMFs to determine the health condition.
